(19) United States
(12) Patent Application Publication
(10) Pub. No.: US 2010/0220573 A1
(43) Pub. Date: Sep. 2, 2010

(54) OPTICAL INFORMATION RECORDING MEDIUM, OPTICAL INFORMATION REPRODUCING METHOD, AND OPTICAL INFORMATION REPRODUCING DEVICE

(75) Inventor: Kazuhiko Aoki, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Minato-ku, Tokyo (JP)

(21) Appl. No.: 12/301,926

(22) PCT Filed: Apr. 19, 2007
(86) PCT No.: PCT/JP2007/058500

§ 371 Date: Nov. 21, 2008

(30) Foreign Application Priority Data
May 23, 2006 (JP) 2006-143326

(51) Int. Cl. G11B 7/26; G11B 7/00

(52) U.S. Cl. 369/100; 369/283; G9B/7; G9B/7.194

(57) ABSTRACT

Provided is an optical information reproducing medium for realizing an excellent super resolution reproduction while performing a high-speed reproduction. The optical information recording medium includes a plurality of super resolution layers (13, 15) whose refractive index or attenuation coefficient changes nonlinearly at predetermined temperatures individually corresponding thereto. Individually on at least two of the super resolution layers (13, 15), the light amounts of the laser beams to be irradiated for causing temperatures of the recording medium to reach the predetermined temperatures are different. The recorded information of the optical information recording medium is reproduced by the areas, in which at least one of the plurality of the super resolution layers has changed in optical characteristic nonlinearly whereas at least one of the remaining layers has not changed in optical characteristic nonlinearly is formed as an aperture.

### TECHNICAL FIELD

The present invention relates to an optical information recording medium, an optical information reproducing method, and an optical information reproducing device for performing reproduction of information by using laser beams. More specifically, the present invention relates to an optical information recording medium, an optical information reproducing method, and an optical information reproducing device, which are preferable to reproduce information recorded in high density.

### BACKGROUND ART

An optical disk is an example of optical information recording media from which information is reproduced by using a laser beam. Optical disks are characterized as having a large capacity and are used broadly as media for distributing/storing images, music, or information in computers.

A capacity of an optical disk is determined depending on the size of pits to be recorded. That is, the smaller the pits to be recorded, the larger the capacity of the optical disk can be. The size of the recorded pits basically depends on converging spot size of laser beams used for reproducing information. That is, with a smaller spot size, still denser information can be reproduced without an error. The spot at which laser beams are converged by an objective lens has a limited expanse, having the laser beams not converged at a point even at the focal point thereof because of a diffraction effect of the light. This is generally referred to as a diffraction limit, which is a limit of the pit length that can be reproduced by λ/(4NA), provided that a laser beam wavelength is λ, and the numerical aperture of the objective lens is NA.

For example, the reproduction limit of the recorded pit length in an optical system of λ=405 nm and NA=0.85 is 119 nm, and the recorded pit in the length equal to or shorter than 119 nm can not be read out accurately. In order to increase the capacity of the optical disk, the wavelength of the laser beams may be shortened or NA of the objective lens may be increased.

However, when the wavelength of the laser beams is set to be shorter than 405 nm, it is difficult to manufacture optical components having a transmittance for practical use at a short wavelength. Further, when NA of the objective lens is set to be larger than 0.85, it is difficult to manufacture a special objective lens with high NA. In addition, there is also such an issue of safety that it becomes highly possible for the objective lens and the optical disk to have a collision because the distance between the objective lens and the disk surface becomes short.

A medium super resolution technique is known as a technique for improving the reproduction resolution power by exceeding the diffraction limit. The medium super resolution uses a super resolution film whose optical characteristic is changed nonlinearly depending on the temperatures or light intensities. Described herein by referring to FIGS. 14 and 15 is a case where a super resolution film whose reflectance changes steeply at a certain temperature or higher, which is depicted in Patent Document 1, for example. In FIGS. 14 and 15, a phase-change material is used for the super resolution film, and the differences in the reflectance at the crystal state (solid phase) and at the melted state (liquid phase), where the temperature is over a melting point, are utilized.

In optical disk 40 shown in FIG. 14, a super resolution film 42 is provided on a transparent substrate 41 on which recorded pits are formed in advance. At reproducing information from the recorded pits, a temperature distribution in a converging spot of the optical disk, which is generated due to a relative shift between the optical disk and the laser beam used for reading according to the rotation of the optical disk, is utilized. The intensity of the laser beam is adjusted such that the temperature at one part of a high temperature area generated in the converging spot exceeds the melting point of the phase-change material used as the super resolution film 42, and a liquid phase state is generated at a part of the super resolution film 42. With this, by making the reflectance at the liquid phase state to be higher than the reflectance at the solid phase state prominently, for example, recorded pits in an area being in the liquid phase state within the converging spot can be read out exclusively.

FIG. 15 is a fragmentary enlarged view of recorded pits of a single track taken out from recorded pits that are formed in advance along a spiral track on a transparent substrate of an optical disk. For simplification, only short pits are illustrated as recorded pits 53 in FIG. 15.

In FIG. 15, a laser beam passing through an objective lens is irradiated on a recording layer as a converging spot 50. Due to absorption of the irradiated laser beam, the temperature is increased near the converging spot 50, and a high temperature area is generated. At a melting area 51 of the high temperature area especially, where the temperature exceeds the melting point, the state of the super resolution film changes from the solid phase state to the liquid phase state, so that the reflectance thereof is increased.

In contrast, at a non-melting area 52 in the converging spot 50, the state is kept as the solid phase state and the reflectance thereof is changed very little. Thus, only the melting area 51 functions as the aperture for reproducing the information of the recorded pits (a part which has an increased reflectance and can be seen by the reflected light therefrom, that is, the aperture functioning as a reflection window formed on the medium). As a result, the size of the aperture that contributes to the reproduction can be made smaller than the size of the converging spot whose size is restricted depending on the diffraction limit. Therefore, it becomes possible to read information of the minute recorded pits 53 that are smaller than the reproduction limit.

As in the case shown in FIG. 15, a super resolution reproduction method, with which the high temperature area of the super resolution film functions as an aperture by the increase in reflectance, so that the aperture is formed in the rear side of the traveling direction of the converging spot, is referred to as RAD (rear aperture detection) method.

The intensity of the light in the converging spot has an approximately Gaussian distribution with the center portion as a peak. Therefore, the area near the center of the converging spot where the intensity of the light is higher can be used for the super resolution reproduction as the position of the aperture generated at the time of the super resolution reproduction becomes closer to the center of the converging spot, and the influence of the light reflected from the area other than the aperture in the converging spot can be decreased.

Although the cases shown in FIGS. 14 and 15 are configured such that the super resolution film is single-layered, there are disclosed the cases in which the super resolution film is double-layered, in Patent Document 2 and Patent Document 3.

In Patent Document 2, disclosed is a technique for reducing the size of an optical aperture (hereinafter referred to as aperture) by using differences in response time of a plurality of the super resolution films. According to Patent Document 2, a common part of the apertures formed on two super resolution films is described to be an aperture of the medium, and FIG. 4 of the Patent Document 2 illustrates an aperture formed by combining the super resolution film of photon-mode system and the super resolution film of heat-mode system. Further, it is also described that even when the two super resolution films are of heat-mode system, the response times can be differentiated by changing the optical absorption rate or the like.

In Patent Document 2, in order to reduce the size of the aperture of the medium, it is required that an offset is generated between the positions of the apertures formed on the two super resolution films, and the mechanism to generate the offset is described in Patent Document 2. That is, an aperture in the super resolution film having fast response time is generated at the substantially center of the optical spot, but when an aperture in the super resolution film having slow response time is generated, the optical spot is shifted in the traveling direction. Consequently, there is an offset generated between these two apertures. Patent Document 3 discloses a super resolution medium that uses two layers of the same thermochromic films. Patent Document 3 shows a result that a C/N ratio of a reproduction signal is higher when using two layers of the thermochromic films compared to the case using a single layer of the thermochromic film.

Patent Document 1: Japanese Unexamined Patent Publication H5-89511

Patent Document 2: Japanese Unexamined Patent Publication 2001-067723

Patent Document 3: Japanese Unexamined Patent Publication 2002-264526

### DISCLOSURE OF THE INVENTION

### Problems to be Solved by the Invention

However, in Patent Document 1, the relative position of the aperture with respect to the converging spot is changed according to the linear speed of the optical disk. Therefore, when the linear speed is increased so as to realize a high speed data transfer, the relative position of the aperture shifts away from the center of the converging spot even if the reproducing power is set adequately, so that the intensity of the light at the area contributing to the super resolution reproduction is weakened.

Therefore, according to Patent Document 1, CNR (carrier to noise ratio) of the super resolution reproduction signal is decreased, and further, the shortest pit length with which the super resolution reproduction becomes possible is increased, that is, the super resolution reproduction power is degraded, under the influence of the light reflected from the area other than the aperture in the converging spot. As a result, a desired performance of the super resolution cannot be obtained.

Further, according to Patent Document 2, since the aperture of the medium is formed with the overlapped apertures of the two super resolution films, an aperture is required to be formed on each of the two super resolution films, and there is a limit to narrow a width of the aperture with respect to the traveling direction of the converging spot.

Furthermore, Patent Document 3 does not at all clarify the object of using two layers of the thermochromic films and a mechanism with which the C/N ratio is increased more in the double layer than in the single layer, and unless the reason why the above described effect can be obtained is clarified, it is impossible to employ it as a technique.

Certainly, since an idea to use two layers of the thermochromic films is suggested in Patent Document 3, it may be supposed to combined Patent Document 3 with Patent Document 2.

However, a dielectric layer is interposed between the two super resolution films in Patent Document 2, whereas a reflection layer which differs from the dielectric layer in its characteristic is interposed between the two thermochromic films in Patent Document 3. Therefore, when Patent Document 2 and Patent Document 3 are combined, two layers of the super resolution films of Patent Document 2 cannot fulfill its function, and it becomes impossible to achieve the prescribed object to form the aperture in the medium by overlapping the apertures of the two super resolution films.

An exemplary object of the invention is to provide an optical information reproducing medium, an optical information reproducing method, and an optical information recording device, which are capable of achieving excellent super resolution reproduction while performing high speed reproduction.

### Means of Solving the Problem

Similar to Patent Document 2 and Patent Document 3, the present invention also uses a plurality of super resolution layers. However, in the present invention, an aperture is formed by overlapping an aperture of one super resolution film with another super resolution film serving as a mask, from among the plurality of super resolution layers.

It is impossible to implement the present invention from a configuration as shown in Patent Document 2, which only laminates two types of super resolution films each having different response times; or from a configuration as shown in Patent Document 3, which interposes a reflection film between two layers of thermochromic films. The present invention can be realized only by a medium configuration as employed in the present invention, which is optically-designed such that the reflectance at the time when one super resolution layer is melted is to be higher than the reflectance in other states.

To achieve the above described exemplary object, an optical information recording medium according to the invention is characterized in that the optical information recording medium, from which information is reproduced by irradiating a laser beam, includes a plurality of super resolution layers whose refractive index or attenuation coefficient changes nonlinearly at predetermined temperatures individually corresponding to the respective layers, and the light amounts of the laser beams to be irradiated onto the recording medium for causing temperatures to reach the predetermined temperatures, respectively, are different from each other for at least each of the two super resolution layers among the plurality of super resolution layers.

According to the present invention, an area in which at least one layer of the plurality of super resolution layers has changed in optical characteristic nonlinearly whereas at least one layer of the plurality of remaining super resolution layers has not changed in optical characteristic nonlinearly is formed as an aperture, thereby the recorded information of the optical information recording medium is reproduced.

When performing the information reproduction by irradiating a laser beam onto the optical information recording medium according to the present invention, the light amount of the laser beam to be irradiated is set such that the respective temperatures of the plurality of the super resolution layers are reached to be higher than the predetermined temperatures corresponding to respective layers.

An optical information reproducing device for performing the information reproduction by irradiating a laser beam onto the optical information recording medium according to the present invention is configured to set the light amount of the laser beam to be irradiated, by an irradiating light amount setting device, such that the respective temperatures of the plurality of the super resolution layers are reached to be higher than the predetermined temperatures corresponding to respective layers.

As described above, according to the present invention, by laminating a plurality of super resolution layers having different thresholds with respect to the irradiated light amount at which the optical characteristic changes nonlinearly, and by forming an area as an aperture in which at least one of the plurality of super resolution layers has changed in optical characteristic nonlinearly whereas at least one of the plurality of super resolution layers has not changed in optical characteristic nonlinearly, it is possible to form an aperture at a position near the center of the converging spot on the medium, and the excellent super resolution reproducing can be performed at a high speed.

Further, an aperture can be formed near the center of the converging spot on the medium regardless of the linear speed of the recording medium, and when reproducing at a high speed for high speed data transfer, excellent super resolution reproduction can be performed.

### BEST MODE FOR CARRYING OUT THE INVENTION

Hereinafter, an exemplary embodiment of the invention will be described in detail by referring to the drawings.

As shown in FIG. 1 and FIG. 3, an optical information recording medium according to the exemplary embodiment of the invention includes, as a fundamental structure, a plurality of super resolution layers (13, 15) whose refractive index or attenuation coefficient changes nonlinearly at predetermined temperatures individually corresponding to the respective layers, and the light amounts of the laser beams to be irradiated onto the recording medium for causing temperatures to reach the predetermined temperatures are different from each other for at least two of the super resolution layers, respectively, among the plurality of super resolution layers.

An area in which at least one super resolution layer (13) of the plurality of super resolution layers has changed in optical characteristic nonlinearly whereas at least one super resolution layer (15) of the plurality of remaining super resolution layers has not changed in optical characteristic nonlinearly is formed as an aperture (22).

Next, the invention will be described using a specific example. The optical information recording medium 10 according to the exemplary embodiment of the invention is configured to be a laminated structure in which a first super resolution film 13 is laminated on a transparent substrate 11 on which recorded pits are formed in advance, with a first dielectric film 12 interposed therebetween, and further, a second super resolution film 15 and a third dielectric film 16 are laminated on the first super resolution film 13, with a second dielectric film 14 interposed therebetween, as shown in FIG. 1. The first super resolution film 13 and the second super resolution film 15 are different from each other in their threshold values with respect to the irradiation light amount at which a nonlinear optical change is occurred.

Note that, FIG. 1 shows a structure in which two layers, i.e., the super resolution films 13 and 15, are laminated, but the super resolution films 13 and 15 may be laminated to be two or more layers.

The super resolution films 13 and 15 used for the optical information recording medium according to the exemplary embodiment of the invention are different from each other in their threshold values with respect to the irradiation light amount at which a nonlinear optical change occurs. FIG. 2 shows a typical reflection characteristic of the medium depending on the difference in threshold value of the irradiation light amount. For simplification, the characteristics of the two super resolution films 13 and 15 are assumed to be changed at the same temperature in FIG. 2. A horizontal axis of the characteristic diagram in FIG. 2 shows a heating temperature applied to the super resolution films, and a vertical axis shows the reflectance of the medium.

As shown in FIG. 2, the reflectance of the optical information recording medium 10 according to the exemplary embodiment of the invention is low when the temperature of the super resolution films 13 and 15 are lower than T1. When the heating temperature applied to the super resolution films is increased to exceed T1, the first super resolution film 13 is melted and optical change is occurred, and the reflectance of the medium 10 becomes higher. Further, when the heating temperature applied to the super resolution films is increased beyond T1 to exceed T2, the second super resolution film 15 is melted, and then the reflectance of the medium becomes lower, again.

Next, described based on FIG. 3 is a positional relationship between a converging spot and an aperture at a converging point on the optical information recording medium 10, associated with the change in reflectance of the medium 10 caused by the heating temperature due to the difference in threshold value of irradiation light amount of the super resolution films 13 and 15 in the optical information recording medium 10 according to the exemplary embodiment of the invention at which a nonlinear optical change occurs. For simplification, only short pits are illustrated as recorded pits 24 in FIG. 3.

When the optical information recording medium 10 having the reflectance characteristic as shown in FIG. 2 is rotated, and a converged laser beam incidents onto the optical information recording medium 10, a circular shaped aperture 22 as shown in FIG. 3 is formed due to a temperature distribution generated on the medium 10.

That is, as shown in FIG. 3, an area 23 of the medium 10 where the temperature is equal to or lower than T1 and an area 21 of the medium 10 where the temperature is equal to or higher than T2 become optical masks whose reflectance are low. Also, a portion in which the converging spot 20 and an area of the medium 10 where the temperature is equal to or higher than T1 and equal to or lower than T2 and whose reflectance is high overlap with each other, becomes an aperture 22.

Accordingly, since the reproduction of recorded data can be performed with the aperture 22 which is smaller than the converging spot 20, the recording density can be heightened. And further, since the width of the aperture with respect to the traveling direction of the converging spot 20 can be made narrow in particular, the recording density can be heightened remarkably in the tracking direction of the optical information recording medium 10, compared to its radial direction.

Next, a change in typical CNR of a single frequency signal corresponding to a shortest pit at a time of changing the linear speed of the optical information recording medium 10 according to the exemplary embodiment of the invention is shown in FIG. 4. In FIG. 4, a solid line indicates an example of a change in CNR according to the exemplary embodiment of the invention, and a dotted line indicates, as a comparative example, an example of a change in CNR when using a single layer of the super resolution film as described in Patent Document 1.

Since a position of the aperture 22 in the converging spot 20 shown in FIG. 3 is changed depending on the temperature distribution, the aperture 22 can be shifted by changing the light amount irradiated onto the optical information recording medium 10. Accordingly, even when the linear speed of the optical information recording medium 10 is changed and the position of the aperture 22 is changed with respect to the converging spot 20, the position of the aperture 22 can always be placed in the vicinity of the center of the converging spot 20 by adjusting the irradiated light amount properly.

Consequently, when the linear speed of the optical information recording medium 10 is increased, the super resolution reproduction can be performed utilizing an area where the intensity of the light is high, and a desired super resolution reproduction performance as shown in FIG. 4 can be obtained. With this, the super resolution reproduction at a high speed, for a high speed data transfer is made possible.

As described, in the optical information recording medium 10 according to the exemplary embodiment of the invention, since the aperture 22 can be formed at the vicinity of the center of the converging spot 20, this super resolution reproduction method is called CAD (center aperture detection) method.

As a material of the super resolution films 13 and 15 in the optical information recording medium 10 according to the exemplary embodiment of the invention described above, a material that is in a crystal state before melting, and back to be in the crystal state again when the temperature thereof becomes lower than the melting point after melting is desirable. This is because the number of repeated reproductions of the optical information recording medium can be increased.

Further, as a material of the super resolution films 13 and 15 in the optical information recording medium 10 according to the exemplary embodiment of the invention, a material that is in a crystal state at an initial state after forming a film is desirable. This is because a process called initialization in which the optical information recording medium 10 is heated and the super resolution films 13 and 15 are made to be in the crystal state can be omitted and the manufacturing process of the optical information recording medium can be simplified.

Also, as a material of the super resolution films 13 and 15 in which an optical characteristic is changed by melting, a chalcogen compound and other phase-change materials can be used. Among those materials, a pseudobinary alloy formed from GeTe and Bi₂Te₃ and the like are preferable for a material that is in a crystal state after forming a film, and back to be in the crystal state again by cooling after melting.

As an example, a configuration of the optical information recording medium in which two types of alloys with different compositions, among from the pseudobinary alloys formed from GeTe and Bi₂Te₃, are used for the super resolution film is illustrated. On a transparent substrate 11 using a polycarbonate, recorded pits, each having a track pitch of 400 nm, a pit depth of 70 nm, a pit width of 100 nm, and a pit length of 50 to 500 nm, were formed.

Next, a first super resolution reproduction film 13 made of GeBi₄Te₇ having a thickness of 10 nm was formed on the transparent substrate 11 with a first dielectric film 12 made of ZnS—SiO₂ having a thickness of 30 nm interposed therebetween.

Further, a second super resolution film 15 made of Ge₁₅Bi₂Te₁₈ having a thickness of 10 nm and a third dielectric film 16 made of ZnS—SiO₂ having a thickness of 90 nm were formed on the first super resolution film 13, with a second dielectric film 14 made of ZnS—SiO₂ having a thickness of 20 nm interposed therebetween.

The change in optical constant (complex refractive index n+ik) of GeBi₄Te₇ (melting point of 573 degrees C.) used for the first super resolution reproduction film 13, depending on the temperature, is shown in FIG. 5. The change in optical constant of Ge₁₅Bi₂Te₁₈ (melting point of 668 degrees C.) used for the second super resolution film 15, depending on the temperature, is shown in FIG. 6. The change in reflectance of the optical information recording medium 10 depending on the temperature is shown in FIG. 7.

As for GeBi₄Te₇ and Ge₁₅Bi₂Te₁s used for the super resolution films 13 and 15 respectively, as clearly shown in FIGS. 5 and 6, the optical constants are steeply changed in the vicinity of the melting points due to the change in phase state, from the solid phase to the liquid phase, with the melting. By combining these two steep optical changes using an optical interference effect of the multi-layer film, the optical information recording medium 10 characterized in that, with an increase in temperature, the reflectance of the medium 10 is increased firstly by the melting of the first super resolution film 13 made of GeBi₄Te₇, then the reflectance of the medium 10 is decreased by the melting of the second super resolution film 15 made of Ge₁₅Bi₂Te₁₈, can be manufactured, as shown in FIG. 7.

At this time, the area on the optical information recording medium 10 where the temperature is more than or equal to about 570 degrees C. and less than or equal to about 670 degrees C. becomes an aperture 22 shown in FIG. 3, and the other areas function as optical masks.

With respect to the optical information recording medium 10 formed as described above, CNR (carrier to noise ratio) of a single frequency signal corresponding to each recorded pit length was measured using an optical system (reproducing limit pit length of 156 nm) of λ=405 nm and NA=0.65, by setting the linear speed of the optical information recording medium 10 as 13.2 m/s and reproducing power as 6 mW. The result is shown in FIG. 8 with a solid line.

Also, as a comparative example, information is reproduced from an optical information recording medium, under the same reproducing condition, in which only a reflection film made of Al having a thickness of 50 nm is formed on the transparent substrate where the same recorded pits are formed. CNR of a single frequency signal corresponding to each recorded pit length is shown in FIG. 8 with a dotted line.

As is cleared from FIG. 8, in the optical information recording medium according to the comparative example in which only a reflection film is formed, no signal was detected from the recorded pit with a length of shorter than 156 nm. Meanwhile, in the optical information recording medium according to the exemplary embodiment of the invention, a signal whose CNR exceeds 40 dB was detected from the recorded pit with a length of 80 nm which is drastically shorter than 156 nm, and it was confirmed that an excellent super resolution reproduction could be performed.

In the exemplary embodiment described above, a case in which the melting points of the super resolution films 13 and 15 are different from each other is described as an example; however, the melting points of the super resolution films 13 and 15 may be the same, that is, the materials of the super resolution films 13 and 15 may be the same. As an example, a configuration of the optical information recording medium 10 in the case when GeBi₂Te₄ (melting point of 583 degrees C.) is used in two super resolution films 13 and 15 will be described.

On the transparent substrate 11 configured by the polycarbonate where the same recorded pits as above described configuration example are formed, a first super resolution film 13 made of GeBi₂Te₄ having a thickness of 10 nm was formed, with a first dielectric film 12 made of ZnS—SiO₂ having a thickness of 30 nm interposed therebetween. Further, a second super resolution film 15 made of GeBi₂Te₄ having a thickness of 10 nm and a third dielectric film 16 made of ZnS—SiO₂ having a thickness of 90 nm were formed on the first super resolution film 13, with a second dielectric film 14 made of ZnS—SiO₂ having a thickness of 100 nm interposed therebetween.

At this time, absorptance (ratio of the light amount absorbed in each super resolution film with respect to the light incident into the optical information recording medium) of the super resolution films 13 and 15, with respect to light having frequency of 405 nm, were 59% for the first super resolution film 13, and 21% for the second super resolution film 15.

FIG. 9 shows the temperature changes of the first and second super resolution films 13 and 15, and the reflectance change at the area on the optical information recording medium where the temperature becomes the highest, when the reproducing power with respect to the optical information recording medium formed as described above is changed, by using the aforementioned optical system and setting the linear speed of the optical information recording medium 10 as 13.2 m/s.

As is clear from FIG. 9, it was confirmed that, when the reproducing power was changed to 4.2 mW, the melting of the first super resolution film 13 was started and the reflectance of the medium 10 was increased, and when the reproducing power was changed to 5.4 mW, the melting of the second super resolution film 15 was started and the reflectance of the medium 10 was decreased.

The result obtained from measuring the CNR of a single frequency signal corresponding to each recorded pit length, by setting the reproducing power as 6 mW, is shown in FIG. 10. Also in this case, as is clear from FIG. 10, an excellent super resolution reproduction in which CNR exceeds 40 dB is performed with respect to the recorded pit having a length of 80 nm.

As described, even when the melting points of the two super resolution films 13 and 15 are the same, the temperature distributions at respective positions of super resolution films 13 and 15 can be made to be different by making the absorptance of irradiated light in respective super resolution films 13 and 15 be different. As the result, sizes of the melting areas in the respective super resolution films 13 and 15 can be differentiated as the case in which the melting points are different from each other, and the desired aperture 22 can be formed.

If the materials of the super resolution films 13 and 15 can be made to be the same, the number of film forming materials required for manufacturing the optical information recording medium 10 can be decreased, and there is such an advantage that it is possible to contribute for a simplification of the medium manufacturing device, reduction in the manufacturing cost, and reduction in the light forming time.

Also, in the exemplary embodiment described above, a case in which the dielectric films 12, 14 and 16, and the super resolution films 13 and 15 are laminated alternatively to configure the optical information recording medium 10, but the configuration of the optical information recording medium 10 is not limited to this, and any configurations are possible as long as the reflectance is changed depending on the presence of the melting of the super resolution film. For example, a reflection film may be provided above the second super resolution film 15. Further, a plurality of dielectric films or translucent metal films having different reflectance may be provided between the transparent substrate 11 and the first super resolution film 13. By increasing a ratio (contrast) of the reflectance depending on the presence of the melting more with these configurations, the influence of the reflected light from the areas other than the aperture 22 in the converging spot 20 can be reduced, and it becomes possible to enhance the quality of the reproduction signal by improving CNR, or increase the recording density by improving the resolution power. Furthermore, if the super resolution film doesn't cause a flow of the film due to the melting at the interface of the super resolution film and another super resolution film, it may be configured with only super resolution films 13 and 15 without the dielectric film. With this, the configuration of the optical information recording medium 10 can be simplified.

Also, in the exemplary embodiment described above, a case in which changes in optical constant of the super resolution films 13 and 15 are caused by the melting of the super resolution films 13 and 15, but causes of the changes in optical constant of the super resolution films 13 and 15 are not limited to these, and any changes in optical constant are available as long as the changes in optical constant are caused by heat generated in the converging spot 20.

Next, an example of the optical information reproducing device for reproducing the recorded information using the optical information recording medium 10 according to the exemplary embodiment of the invention will be described referring to FIG. 11.

The optical information reproducing device according to the exemplary embodiment of the invention includes an optical head unit 31, a reproduction circuit 32, an asymmetry detection unit 33, a laser power adjusting unit 34, and a laser drive circuit 35, as shown in FIG. 11. Here, the asymmetry detection unit 33, the laser power adjusting unit 34, and the laser drive circuit 35 configure an irradiation light amount setting device for setting the light amount of the laser beam irradiated from the optical head unit 31 in such a manner that respective reaching temperatures of the plurality of the super resolution films 13 and 15 become higher than the corresponding predetermined temperatures.

The optical head unit 31 has a function of detecting information recorded in the optical information recording medium 10 as a change in intensity of the reflected light of the irradiated laser beam. The reproduction circuit 32 has a function of reading the recorded information from the optical head unit 31 as a reproduction signal. The asymmetry detection unit 33 has a function of extracting the asymmetry information from the reproduction signal read by the reproduction circuit 32. The laser power adjusting unit 34 has a function of controlling an instruction value of the intensity of the laser beam to be supplied to the laser drive circuit 35 based on the asymmetry information extracted by the asymmetry detection unit 33. The laser drive circuit 35 has a function of driving a laser provided inside the optical head unit 31 in order that the intensity of the laser beam matches with the instruction value, in accordance with the instruction value of the intensity of the laser beam that is supplied from the laser power adjusting unit 34.

Next, described is actions of the optical information reproducing device according to the exemplary embodiment of the invention shown in FIG. 11 when the recorded information is reproduced from the optical information recording medium 10 shown in FIG. 1.

First, the laser drive circuit 35 drives the laser provided within the optical head unit 31, in accordance with an initial instruction value of the intensity of the laser beam that is supplied from the laser power adjusting unit 34. Information recorded on the optical information recording medium 10 is detected by the optical head unit 31 as a change in intensity of the reflected light of the irradiated laser beam, read as a reproduction signal through a reproduction circuit 32, and asymmetry information is extracted at an asymmetry detection unit 33.

For the initial instruction value of the intensity of the laser beam, a value Po, registered in the laser power adjusting unit 34 in advance as the intensity of the laser beam for this type of the optical information recording medium 10, is used. This time, the aperture 22 shown in FIG. 3 is formed near the center of the converging spot 20, and the bit error rate of the super resolution reproduction signal takes the minimum value BERo as shown in FIG. 12 by a solid line.

However, since the intensity of the laser beam with which the bit error rate takes minimum value is varied depending on variations in the optical characteristic or thermal characteristic of each optical information recording medium 10, or, variations in the environmental temperatures, the intensity sometimes shifts from the intensity of the laser beam registered in advance. In such cases, if the intensity of the laser beam is kept at the value registered in advance, the position of the aperture 22 which contributes to the super resolution reproducing is offset from the center of the converging spot 20, and a proper super resolution effect cannot be maintained. For example, when the environmental temperature increases, and the curve shown in FIG. 12 indicating a relationship between the intensity of the laser beam and the bit error rate is shifted to the low intensity side, as in a shift from a solid line to a dotted line in FIG. 12, if the intensity of the laser beam is remained as Po, the aperture 22 is formed at a position apart from the center of the converging spot 20. Consequently, the bit error rate is increased to BER1 that is larger than the minimum value.

Therefore, in this exemplary embodiment, the intensity of the laser beam is adjusted to be adequate for the super resolution reproducing by using the asymmetry information which is varied depending on the position of the aperture 22. The relationship between the intensity of the laser beam and the asymmetry is shown in FIG. 13.

Accordingly, the instruction value of the intensity of the laser beam for the laser drive circuit 35 is adjusted by the laser power adjusting unit 34 such that the asymmetry takes an optimum value Ao based on the asymmetry information extracted by the asymmetry detection unit 33. Specifically, when the asymmetry takes the value such as A1 that is smaller than the optimum value Ao, the intensity of the laser beam is changed to a minus direction. Inversely, when the asymmetry takes the value larger than the optimum value Ao, the intensity of the laser beam is changed to a plus direction. Through controlling the intensity of the laser beam so that the asymmetry takes the optimum value Ao at all times, the intensity of the laser beam becomes a new optimum value Po' with which the bit error rate becomes minimum, and at this time, the bit error rate of the reproduction signal also takes the minimum value BERo.

As a result, even when there are variations in thermal and optical characteristics of the optical information recording medium 10 or when there is external fluctuating factors such as environmental temperatures, the position of the aperture which contributes to the super resolution reproducing can be kept at a desirable position at all times, and it becomes possible to perform the stable super resolution reproducing.

For the optimum value of the asymmetry with which the bit error rate becomes minimum, the value which is registered to the laser power adjusting unit 34 in advance as the asymmetry optimum value for this type of the optical information recording medium 10 may be used. Also, a value recorded in a prescribed area of the optical information recording medium 10 as the asymmetry optimum value of the optical information recording medium 10 may be used. Further, if the information is recorded such that the asymmetry optimum value becomes zero, a pre-registration of the asymmetry optimum value to the laser power adjusting unit 34, or pre-recording of the value to the optical information recording medium 10, can be omitted.

More desirably, in the combinations of each of the optical head unit 34 and the optical information recording medium 10, the optimum value of the asymmetry with which the bit error rate becomes minimum is calibrated. This calibration can be performed at a test area provided appropriately in a region where user information is not recorded, such as an inner peripheral part or an outer peripheral part of the optical information recording medium 10 for example, by using a test pattern recorded in advance for measuring the bit error rate.

In the exemplary embodiments described above, the intensity of the laser beam is adjusted based on the asymmetry, but the method of adjusting the intensity of the laser beam is not limited to this, and it is also possible to perform the adjustment by using other indicators expressing the state of the reproduction signal. For example, there is a method of using a ratio of the amplitudes of the reproduction signals from a several types of pits having different receiving light amounts, or different amplitude or a length of the reproduction signal, instead of the asymmetry.

### INDUSTRIAL APPLICABILITY

As described above, according to the present invention, by laminating a plurality of the super resolution layers having different thresholds with respect to the irradiated light amount, at which the optical characteristic changes nonlinearly, and by making an aperture at an area in which at least one of the super resolution layer has changed in optical characteristic nonlinearly whereas at least one of the super resolution layer has not changed in optical characteristic nonlinearly, it is possible to form an aperture at a position near the center of the converging spot on the medium, and the excellent super resolution reproducing can be performed at high speed.

### BRIEF DESCRIPTION OF THE DRAWINGS

FIG. 1 is a sectional view showing an optical information recording medium according to an exemplary embodiment of the invention;

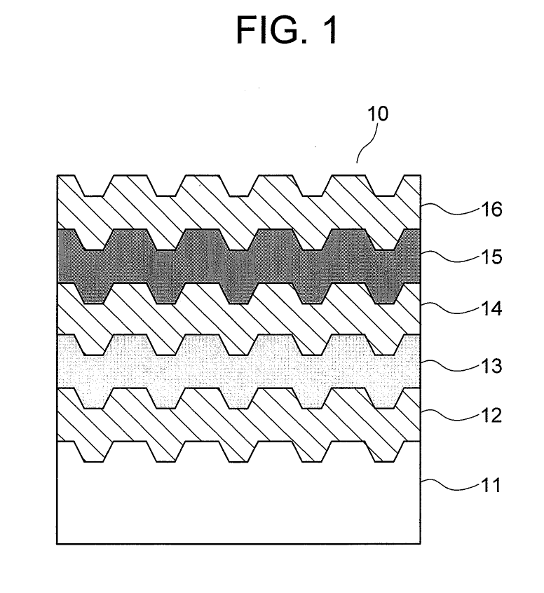

FIG. 2 is a characteristic diagram showing a change in reflectance depending on the temperature of the optical information recording medium according to an exemplary embodiment of the invention;

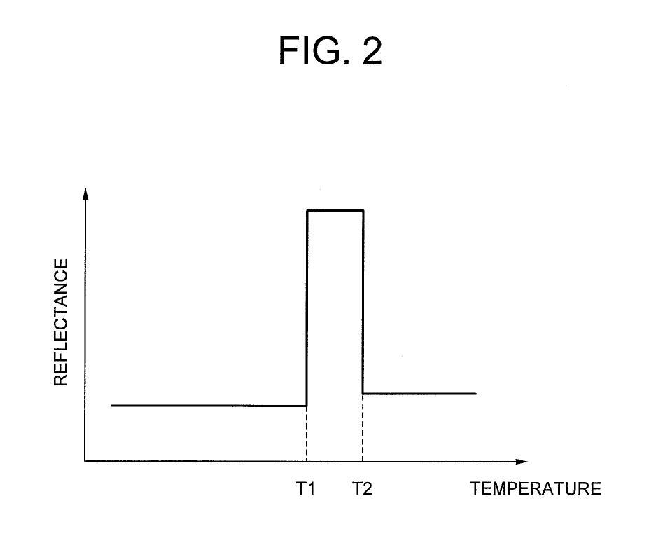

FIG. 3 is a conceptual diagram showing a positional relation between a converging spot and an aperture at a converging point on the optical information recording medium according to an exemplary embodiment of the invention;

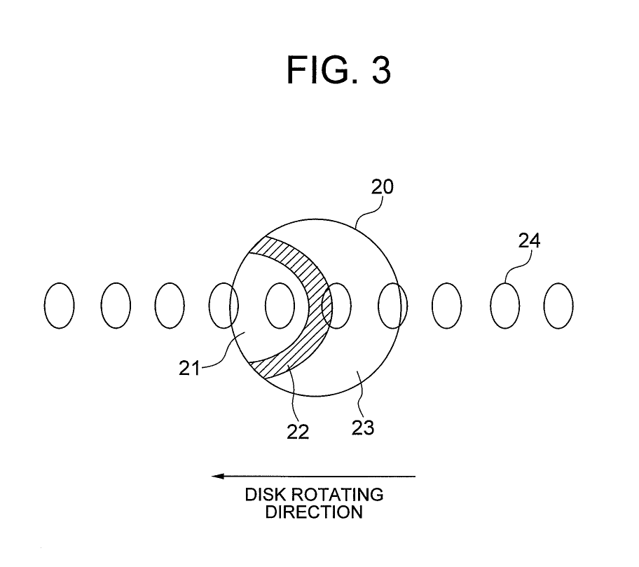

FIG. 4 is a characteristic diagram showing a change in CNR of a signal corresponding to a shortest pit when a linear speed of the optical information recording medium according to an exemplary embodiment of the invention is changed;

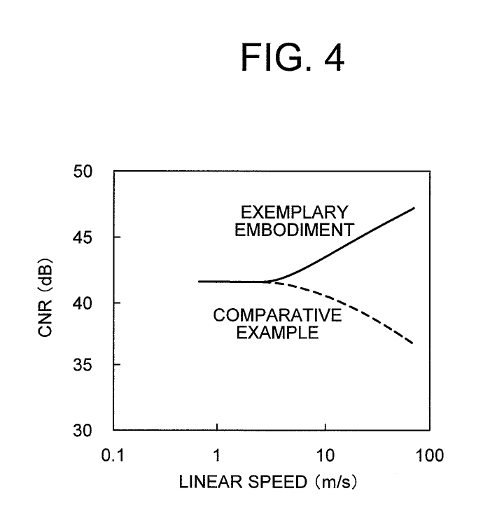

FIG. 5 is a characteristic diagram showing a change in optical constant depending on the temperature of GeBi₄Te₇ forming a super resolution film;

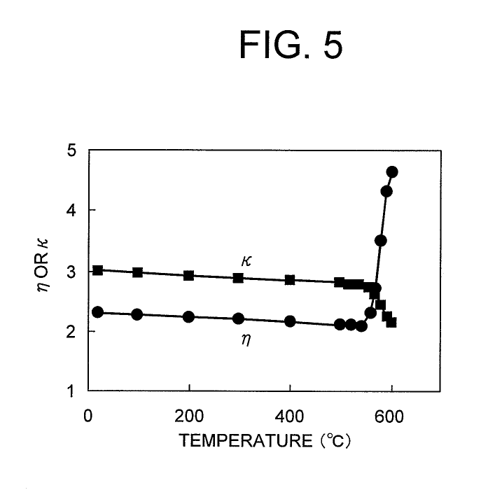

FIG. 6 is a characteristic diagram showing a change in optical constant depending on the temperature of Ge₁₅Bi₂Te₁₈ forming a super resolution film;

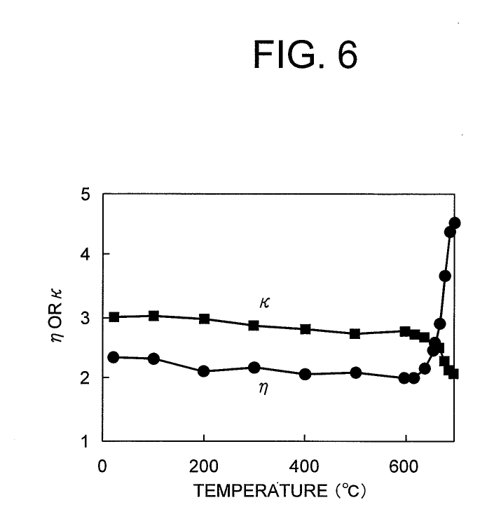

FIG. 7 is a characteristic diagram showing a change in reflectance depending on the temperature of the optical information recording medium according to an exemplary embodiment of the invention;

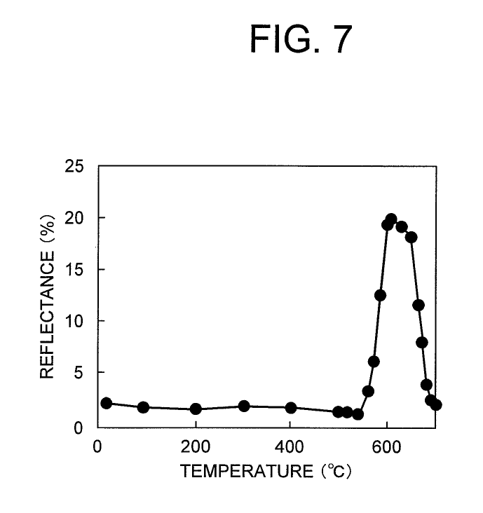

FIG. 8 is a characteristic diagram showing CNR of a signal corresponding to each pit length;

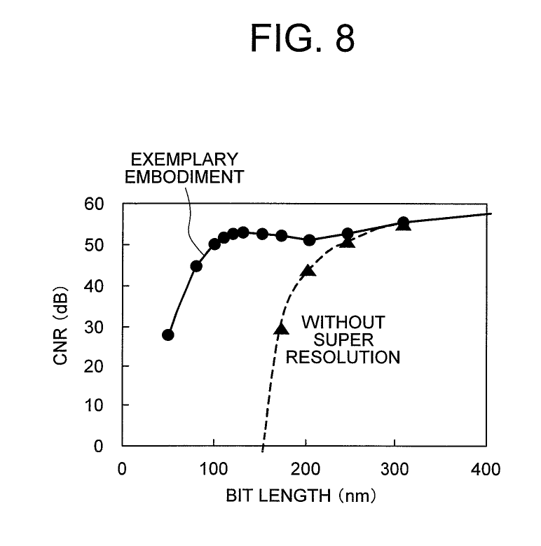

FIG. 9 is a characteristic diagram showing a change in temperature of an optical information recording medium according to an exemplary embodiment of the invention depending on a reproducing power and a change in reflectance at an area whose temperature is the highest on the recording medium;

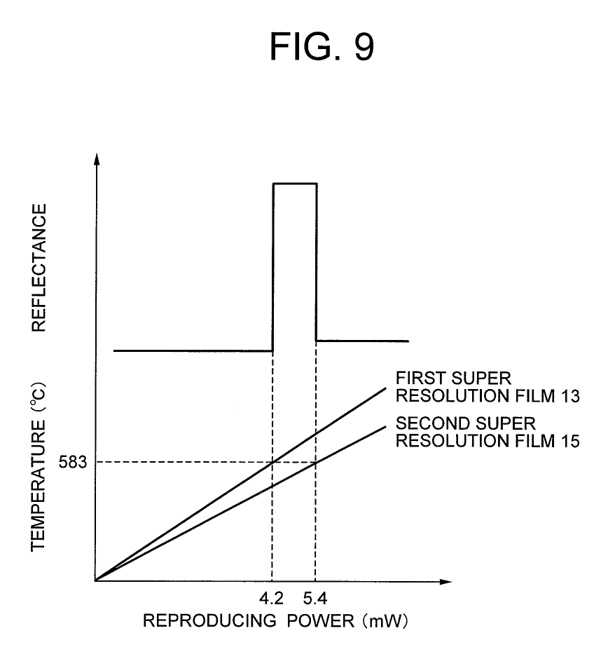

FIG. 10 is a characteristic diagram showing CNR of a signal corresponding to each pit length;

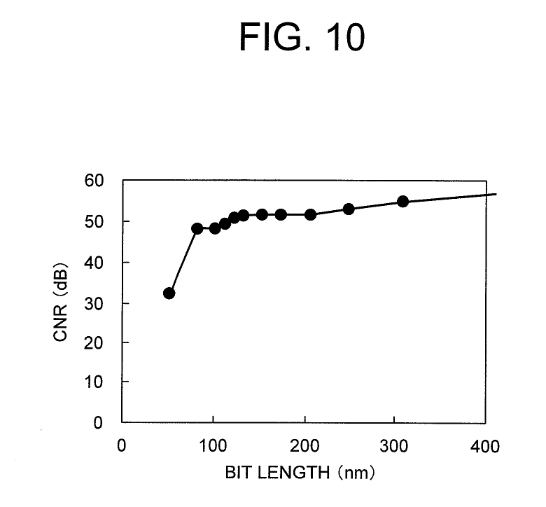

FIG. 11 is an overall block diagram showing an example of the optical information recording medium according to an exemplary embodiment of the invention;

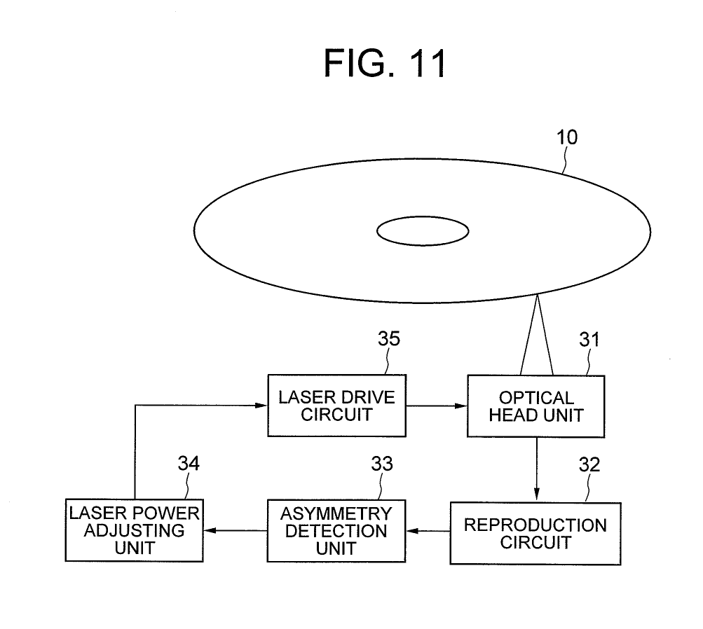

FIG. 12 is a drawing showing a relation between a laser beam intensity and a bit error rate at the super resolution reproduction;

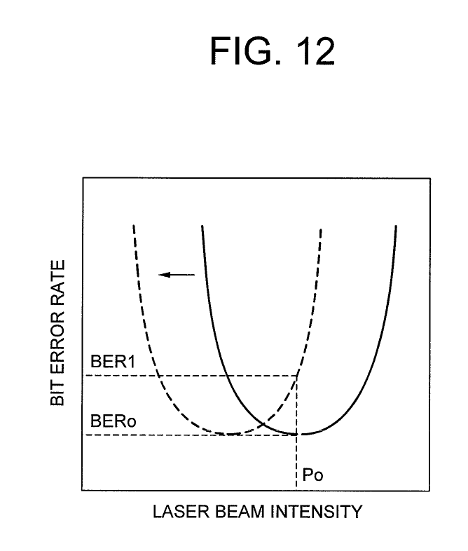

FIG. 13 is a drawing showing a relation among a laser beam intensity, a bit error rate, and an asymmetry at the super resolution reproduction;

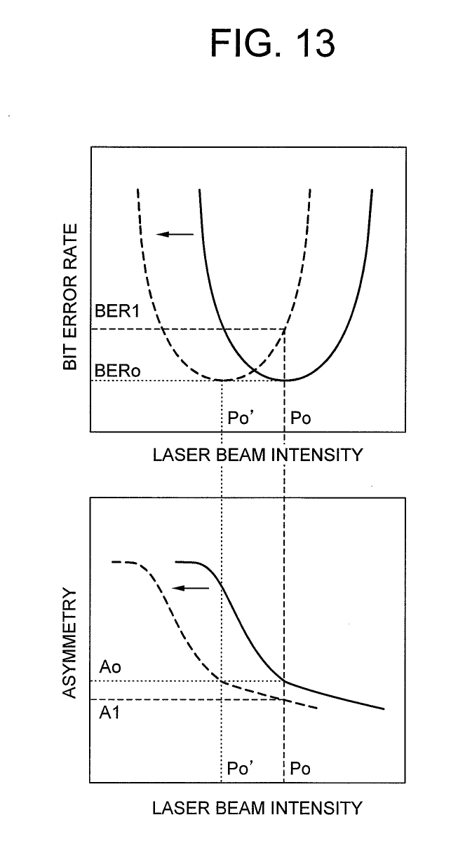

FIG. 14 is a sectional view showing an optical disk according to a traditional art; and

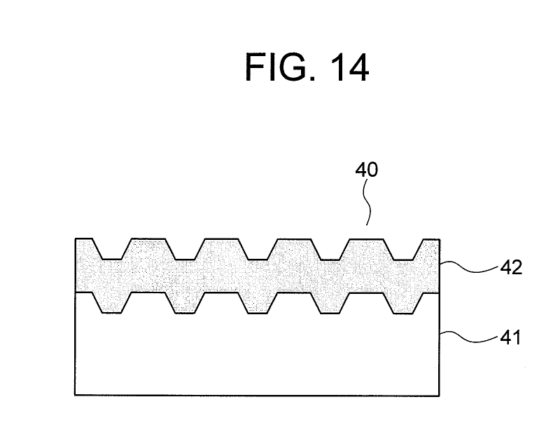

FIG. 15 is a plan view showing the principle of the super resolution reproduction in a medium super resolution.

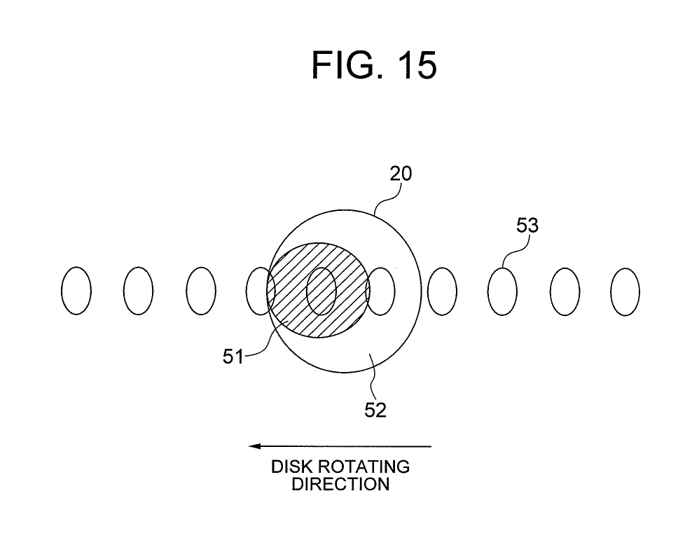

### REFERENCE NUMERALS

Optical information reproducing medium
11 Transparent substrate
12 First dielectric film
13 First super resolution film
14 Second dielectric film
15 Second super resolution film
16 Third dielectric film
20 Converging spot
21 Area at which temperature is equal to or more than T2
22 Aperture
23 Area at which temperature is equal to or less than T1
24 Recorded pit
31 Optical head unit
32 Reproducing circuit
33 Asymmetry detection unit
34 Laser power adjusting unit
35 Laser drive unit
40 Optical disk
41 Transparent substrate
42 Super resolution film
50 Converging spot
51 Melting area
52 Non-melting area
53 Recorded pit

1-10. (canceled)

11. An optical information recording medium from which information is reproduced by an irradiation of a laser beam, the optical information recording medium comprising:
a plurality of super resolution layers whose refractive index or, attenuation coefficient changes nonlinearly at predetermined temperatures corresponding to respective layers, wherein
light amounts of the laser beams to be irradiated onto the recording medium required for causing temperatures to reach the predetermined temperatures, respectively, are different from each other for at least two of the super resolution layers, among the plurality of super resolution layers, and when the temperature of at least one of the plurality of super resolution layers is higher than the predetermined temperature corresponding thereto and a temperature of at least another one of the plurality of super resolution layers is lower than the predetermined temperature corresponding thereto, a reflectance of the medium is higher than a reflectance at a time when respective temperatures of the plurality of super resolution layers are lower than the predetermined temperatures corresponding thereto, and a reflectance at a time when respective temperatures of the plurality of super resolution layers are higher than the predetermined temperatures corresponding thereto.

12. The optical information recording medium as claimed in claim 11, wherein at least two of the plurality of super resolution layers have a same material composition.

13. The optical information recording medium as claimed in claim 11, wherein the light amounts of the laser beam absorbed by the plurality of super resolution layers are different from each other for respective layers.

14. The optical information recording medium as claimed in claim 11, wherein the predetermined temperature corresponding to at least one of the plurality of super resolution layers is equal to a melting point of the at least one of the plurality of super resolution layers.

15. The optical information recording medium as claimed in claim 14, wherein, when the temperature of at least one of the plurality of super resolution layers is lower than the melting point of the at least one of the plurality of super resolution layers, the super resolution layer is in a crystal state.

16. The optical information recording medium as claimed in claim 14, wherein at least one of the plurality of super resolution layers is composed mostly of a pseudobinary alloy that is in a crystal state after forming a film, and back to be in the crystal state again with cooled after melting.

17. An optical information recording method for reproducing information by irradiating a laser beam onto an optical information recording medium,
the optical information recording medium including a plurality of super resolution layers whose refractive index or attenuation coefficient changes nonlinearly at predetermined temperatures corresponding to respective layers, and light amounts of the laser beams to be irradiated onto the recording medium for causing temperatures to reach the predetermined temperatures, respectively, being different from each other for at least two of the super resolution layers among the plurality of super resolution layers,
the optical information recording method comprising setting light amounts of the laser beams to be irradiated in such a manner that the respective temperatures of the plurality of super resolution layers become higher than the predetermined temperatures corresponding thereto; and
in a plurality of super resolution layers having different thresholds with respect to the irradiated light amount at which the optical characteristic changes nonlinearly, forming an area in which at least one of the plurality of super resolution layers has changed in optical characteristic nonlinearly whereas at least one of the plurality of super resolution layers has not changed in optical characteristic nonlinearly as an aperture.
